(19) United States
(12) Patent Application Publication
(10) Pub. No.: US 2009/0266847 A1
(43) Pub. Date: Oct. 29, 2009

(54) Dispenser for Particulate Material

(75) Inventors: Oren Binder, Rishon Letzion (IL); Ilan Ben-Meir, Haifa (IL)

Correspondence Address: THE NATH LAW GROUP, 112 South West Street, Alexandria, VA, 22314, US

(73) Assignee: Strauss Group Ltd., Petach Tikva (IL)

(21) Appl. No.: 12/309,589

(22) PCT Filed: Jul. 24, 2007
(86) PCT No.: PCT/IL2007/000928

§ 371 Date: Apr. 24, 2009

(30) Foreign Application Priority Data
Jul. 26, 2006 (IL) 177096

(51) Int. Cl. B65D 88/54

(52) U.S. Cl. 222/305

(57) ABSTRACT

A dispenser adapted to dispense one of at least two predetermined amounts of particulate materials from a container, the dispenser comprising a container support and at least two dispensing chambers, each being movable from a first position wherein it is located so as receive particulate materials from the container to a second position wherein it is located so as to dispense particulate materials stored therein. A first of the dispensing chambers has a volume equal to that of a first predetermined amount. The first dispensing chamber and at least one other dispensing chamber have a combined volume equal to a second predetermined amount.

### FIELD OF THE INVENTION

This invention relates to dispensers adapted to dispensers for particulate material such as granulated material and powders, of the type commonly added to a liquid to prepare a beverage or as an additive therefore.

### BACKGROUND OF THE INVENTION

It is very convenient to provide particulate materials in granular or powder form to mix into a liquid to prepare a beverage. Common examples include instant coffee, chocolate milk, hot cocoa, fruit flavored drinks, etc. Often, the correct proportion of the particulate materials to the liquid is not rigidly defined, but there is a generally accepted range which is considered acceptable. Stronger or weaker beverages can be obtained by using more or less of the particulate materials, respectively. Additives in granulate or powder form, such as sugar, sweeteners and flavors may also be conveniently added to a beverage.

In multi-user environments, such as in offices or hospitals etc., it is often desirable to provide a dispenser which dispenses a predetermined amount of particulate materials for preparing a beverage.

U.S. Pat. No. 3,750,912 discloses a powder dispenser for dispensing a metered predetermined volume of powder, such as instant coffee. A ratchet arm is slideably received within a slot in the bottom of a container. The ratchet arm is spring-biased outwardly with a retaining shoulder and has a plurality of teeth in contact with the teeth of a circular ratchet gear which is fixedly attached to a stirring paddle rotating with the ratchet gear and stirring the contents of the housing. A dispensing disc is provided, coupled to the ratchet gear and disposed over a bottom plate in the housing. The dispensing disc has a plurality of apertures dimensioned for carrying a pre-metered volume of powder. A spring detent is provided for centering the apertures over an aperture in the bottom plate and for drop activation of the contained metered powder.

U.S. Pat. No. 5,186,366 discloses an apparatus for dispensing a metered amount of ground coffee. The apparatus comprises a housing and a rotatable metering assembly. The housing has a storage chamber for the coffee and an isolated passageway terminating in a spout. The storage chamber has an outlet at its bottom. The metering assembly includes plural metering chambers located below the outlet of the storage chambers and which, when the assembly is rotated, brings a number of them under the outlet, whereupon the particulate material flows therein. The housing also has a wiper disposed at the outlet to wipe extra particulate material from the filled metering chambers as the metering assembly is rotated so that they do not overflow. The rotation of the metering assembly to selected rotational positions brings a selected number, i.e., one or more, of the filled receiving chambers into communication with the passageway, whereupon the user of the apparatus may invert it so that the coffee from the one or more receiving chambers flows into the passageway at one time to exit at the spout. The housing also includes a pair of covers, pivotally connected to each other, for closing off the cavity and the pouring spout.

U.S. Pat. No. 4,053,087 discloses a dispenser for granular material such as sugar and coffee or other beverage ingredients, having a bucket-type valve assembly which assures accurate dispensing of predetermined amounts of the desired material through a quick-acting spring device. A coin operated latch mechanism can be used for actuation of the dispenser.

### SUMMARY OF THE INVENTION

The present invention calls for a dispenser adapted to dispense one of at least one predetermined amount of particulate materials from a container.

According to one aspect of the present invention, there is provided a dispenser adapted to dispense one of at least two predetermined amounts of particulate materials. The dispenser comprises a container support and at least two dispensing chambers. Each dispensing chamber is movable from a first position wherein it is located so as receive particulate materials from the container to a second position wherein it is located so as to dispense particulate materials stored therein. A first of the dispensing chambers has a volume equal to that of a first predetermined amount. The first dispensing chamber and at least one other dispensing chamber have a combined volume equal to a second predetermined amount.

In addition, the dispensing chamber may be embodied by one or more modifications, as described below. It will be appreciated that the dispensing chamber may comprise any one more of the modifications in any combination.

Each of the dispensing chambers, in its first position, may be below and in flow communication with a particulate materials inlet, which is the point of ingress of the particulate material to the dispensing chambers from the container, and in its second position, be above and in flow communication with a particulate materials outlet, which is the point of egress of the particulate material from the dispensing chamber.

The dispensing chamber may be adapted to be in flow communication with only one of the particulate materials inlet and particulate materials outlet at any instant.

Each of the at least two dispensing chambers may be formed within a slide, which may be arranged vertically.

According to an embodiment, the dispenser is constructed such that when one of at least two slides is displaced, at least one additional slide is displaced in tandem therewith.

All of the at least one additional slide may be successively contacting the slide. Hereafter in the specification and claims, the term “successively contacting” is to be understood as referring to an arrangement of two or more items, wherein each item is either contacting each other item or to another one of the items which is successively contacting it.

The dispenser according to this aspect of the invention may further be embodied by one or more of the following:
the other (i.e., not the first) dispensing chambers are successively contacting the first dispensing chamber;
the first dispensing chamber is formed within a bottommost slide;
the dispenser further comprises at least two buttons, each associated with a different slide and corresponding to dispensing a different predetermined amount of particulate material;
the at least buttons are adapted to bear against a corresponding slide when depressed;
the dispenser is free of any means adapted to cause a movement of a button due to an independent movement of its corresponding slide;
the dispenser may further comprises a delay mechanism adapted to temporarily restrain at least one slide from returning to a forward (i.e., un-depressed, rest) position after a button is depressed and released;
the delay mechanism may comprise:
   a restraining mechanism adapted, in a first position, to prevent the at least one slide from returning to its forward position and, in a second position, to allow the at least one slide to return to its forward position; and
   a control mechanism adapted to move in concert with the button and to bring the restraining mechanism from its first position to its second position when the button is at or near its forward position.
at least surfaces of the slides which contact each other are made from or coated with a low-friction material, such as polytetrafluoroethylene; and
the dispenser is adapted to selectively dispense from two or more containers.

The dispenser may further comprise at least one loosening mechanism for loosening the particulate materials. The loosening mechanism is responsive to a movement associated at least with the movement of at least one of the dispensing chambers from its first position to its second position, as follows:
The loosening mechanism may be adapted for loosening the particulate material within the container. For example:
   It may be an agitator situated so as to project into the container. The loosening is accomplished by movement of the agitator within the container. The agitator may comprise prongs extending radially therefrom.
   It may be a striking device adapted to strike the container or a component of the dispenser in contact therewith.
   It may comprise a container-bearing portion adapted to be biased toward an inner wall of container when received within the container support, and may further comprise bristles formed thereon.
The loosening mechanism may be adapted for loosening the particulate material within at least one of the dispensing chambers. For example:
   It may comprise a clapper, a clapper initializer configured for movement with the first of the dispensing chamber, and a striking surface being in vibrational communication said dispensing chamber. The clapper, clapper initializer, and striking surface are arranged such that upon movement the dispensing chamber toward its second position, the clapper initializer displaces or deforms the clapper from a rest position thereof, and upon further movement of the dispensing chamber to the second position, the clapper strikes the striking surface. The clapper may further comprise a weight.
   It may comprise a toothed wheel.

The dispenser may comprise one or more of the two above-described loosening mechanisms.

The dispenser may further comprise a clapper, a clapper initializer configured for movement with the first of the dispensing chambers, and a striking surface. The clapper, clapper initializer, and striking surface are arranged such that upon movement the dispensing chamber toward its second position, the clapper initializer displaces or deforms the clapper from a rest position thereof, and upon further movement of the dispensing chamber to the second position, the clapper strikes the striking surface, thereby producing an audible sound.

The dispenser may further comprise spacers disposed between adjacent dispensing chambers. Each of the spacers have a through-going aperture formed so as to conform to the shape of the dispensing chambers, and are biased toward the dispensing chamber therebelow.

The dispenser may further comprise a canopy adapted, at least when a container is received within the container support, to prevent particulate material from falling directly from the container into the dispensing chambers.

The dispenser may further comprise a rotatable ring adapted to activate the loosening mechanism. The ring may be adapted to rotate in response to the displacement of at least one of the dispensing chambers from its first position to its second position.

The dispenser may be adapted to sealingly receive the container.

The dispenser may be adapted to receive therein a retail canister of particulate materials. In this way, for example, a standard canister of powdered coffee can be mounted to the machine and constitute the container, with no need to transfer its contents.

The particulate materials may be adapted to be added to a liquid. The liquid and particulate materials therein may constitute a beverage.

According to another aspect of the present invention, there is provided a mounting plate adapted to support at least one dispenser, such as described above. The mounting plate may be adapted to support two or more dispensers. The dispensers may be adapted to be supported by the mounting plates from a back side thereof.

According to a further aspect of the present invention, there is provided a dispensing array comprising at least two dispensers, as described above, supported adjacent to one another. The dispensing array may further comprise a mounting plate adapted to support two or more dispensers, such as that described above.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIGS. 1A and 1B are perspective views of a dispenser according to the present invention, with and without a container mounted thereon, respectively;

FIG. 2 is a front perspective exploded view of a dispensing portion of the dispenser;

FIG. 3 is rear perspective view of components of the dispensing portion;

FIG. 4A is a front perspective view of a button of the dispensing portion;

FIG. 4B is a cross-sectional view taken along line IV-IV in FIG. 4A;

FIGS. 5A and 5B are top-front and bottom-rear perspective views, respectively, of a bottommost slide of the dispensing portion;

FIG. 5C is a partial cross-sectional view taken at line V-V in FIG. 5A;

FIGS. 6 and 7 are perspective views of middle and topmost slides, respectively, of the dispensing portion;

FIG. 8 is a perspective view of a spacer of the dispensing portion;

FIG. 9 is a cross-sectional view of a container support of the dispensing portion;

FIGS. 10A and 10B are perspective and bottom views, respectively, of a rotating ring of dispensing portion;

FIG. 10C is a perspective view of the rotating ring illustrated in FIGS. 10A and 10B, with an agitator mounted thereon;

FIG. 11A is a perspective view of the rotating ring with a cam mounted thereon;

FIG. 11B is a perspective view of the cam;

FIGS. 12A and 12B are different perspective views of a striking mechanism of the dispensing portion;

FIG. 13A illustrates the buttons, slides, and spacer illustrated in FIGS. 4A, and 5A through 8, as arranged within the dispensing portion;

FIG. 13B is a cross-sectional view taken along line II-II in FIG. 13A;

FIG. 13C is a close-up of the area indicated as ‘A’ in FIG. 13B;

FIGS. 14A and 14B are bottom perspective views of different components as arranged within the dispensing portion;

FIG. 15 is a rear perspective view of the dispenser as illustrated in FIG. 1A;

FIGS. 16A through 16C illustrate several mounting plates;

FIG. 16D illustrates a dispensing array;

FIG. 17 is a perspective view of the bottommost slide illustrated in FIGS. 5A and 5B according to a modification of the present invention;

FIG. 18 illustrates a spacer according to another modification of the present invention;

FIG. 19A is a perspective view of a rear casing of the dispenser according to a further modification of the present invention;

FIG. 19B is a partial cross-sectional view taken along line VII-VII in FIG. 17;

FIG. 20 is a perspective view of the agitator illustrated in FIG. 10C according to a still further modification of the present invention;

FIG. 21 is a bottom view of the rotating ring illustrated in FIGS. 10A and 10B according to a still further modification of the present invention;

FIG. 22A is a partial cutaway view of a container support portion of the dispenser illustrated in FIGS. 1A and 1B, according to different modifications;

FIG. 22B is a closeup view of the area indicated as ‘B’ in FIG. 22A, from a slightly different angle; and

FIG. 23 is a rear perspective view of interior components of the dispenser according to further modification.

### DETAILED DESCRIPTION OF EMBODIMENTS

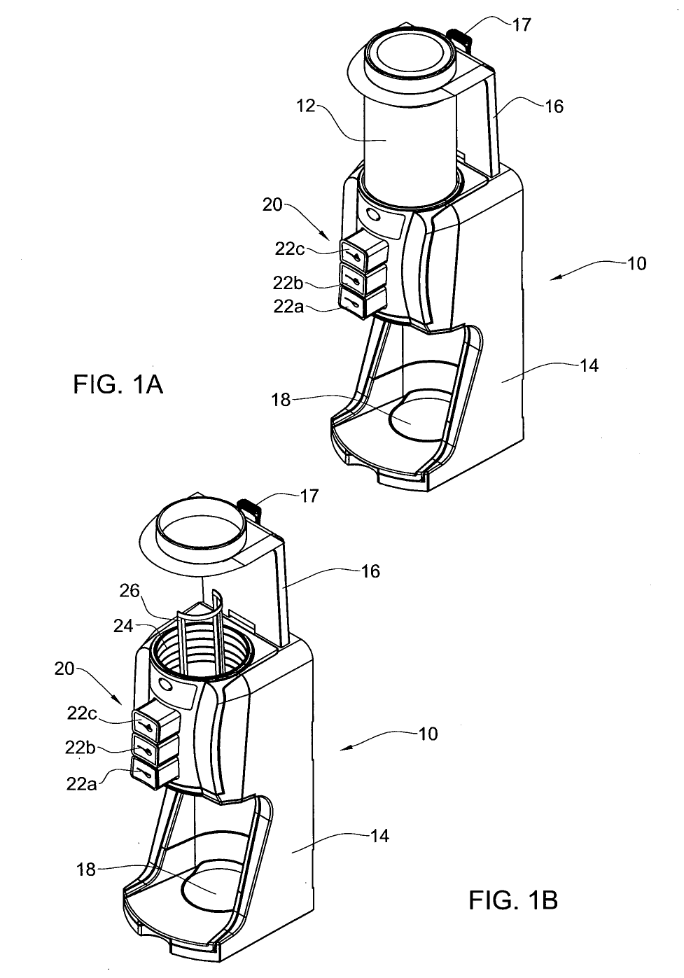

As illustrated in FIGS. 1A and 1B, there is provided a dispenser, generally indicated at 10, for dispensing from a container 12, such as a canister, one of several predetermined quantities of a particulate material, such as powder, granules, a freeze-dried beverage, or the like, to be added to a liquid to make a beverage, coffee, chocolate milk, cocoa, etc.

The dispenser 10 comprises a base portion 14 and a container support 16 projecting therefrom. A locking mechanism 17 is provided to maintain the position of the container support 16, and which is adapted to be depressed, thereby releasing the container support. This is provided to prevent someone who is inexperienced in using the dispenser 10 from accidentally removing the container 12. This is especially important since, as will become clear below, the container 12 is installed such that the opening thereof is facing downwardly. Accidental removal of the container is likely to result in undesired spilling of the contents thereof. The base portion 14 comprises a cup support platform 18 below a dispensing portion, generally indicated at 20. The space between the cup support platform 18 and the dispensing portion 20 is sufficient to receive therein a cup (not illustrated).

The dispensing portion 20 comprises several buttons 22a, 22b, and 22c, each associated with a different predetermined quantity of the particulate material to be dispensed. The bottommost button 22a is associated with the smallest quantity, with each successively higher button associated with a larger quantity. In addition, as best seen in FIG. 1B, the dispensing portion 20 comprises an opening 24 sized to received the container 12. An agitator 26, constituting a loosening mechanism, projects upwardly from the opening 24.

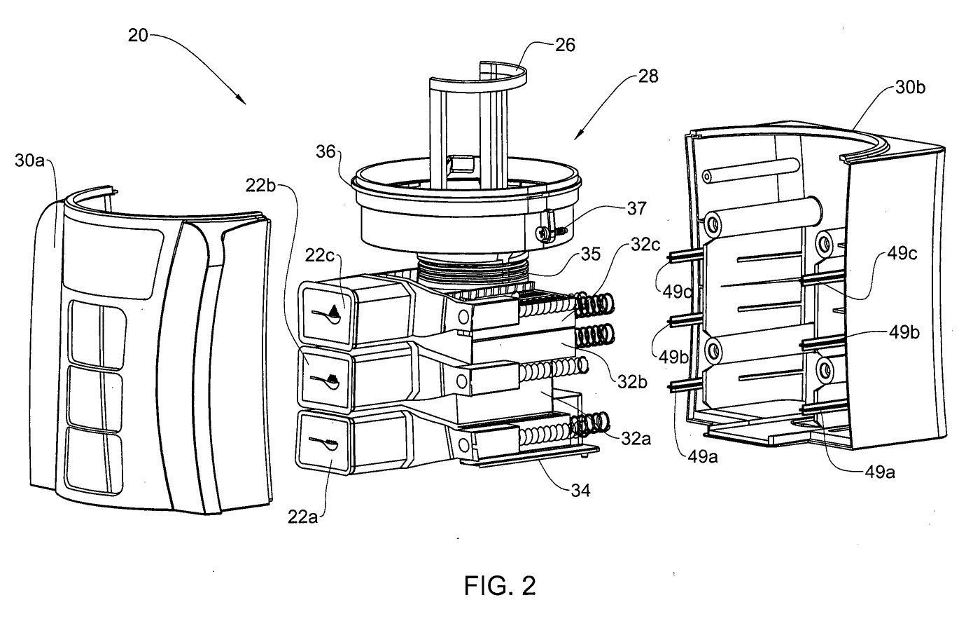

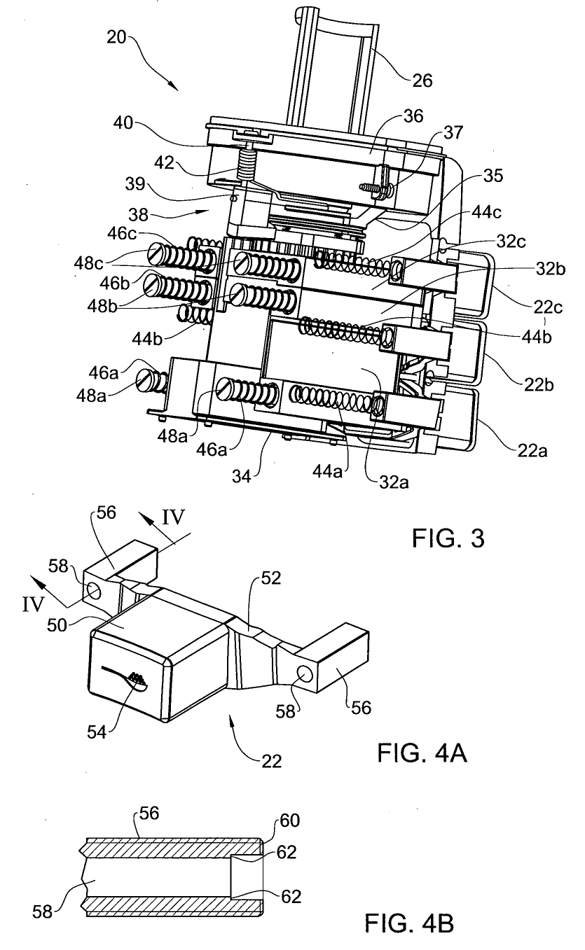

As seen in FIGS. 2 and 3, the dispensing portion 20 comprises a dispensing mechanism, generally indicated at 28, housed within front and rear casings 30a, 30b. As can be seen, the buttons 22a-22c and agitator 26 constitute parts of the dispensing mechanism 28. The dispensing mechanism 28 further comprises three stacked slides 32a, 32b, and 32c each associated with one of the buttons 22a, 22b, and 22c, respectively, and a spacer 34. Each slide 32a, 32b, and 32c is slideable with respect to adjacent slides. A rotatable ring 35 is connected to the agitator 26, and a container support 36 defines the opening 24. The container support 36 is fixed with respect to the rear casing 30b, such as by two screws 37.

As seen in FIG. 3, the dispensing portion 20 further comprises a striking mechanism, generally indicated at 38 and constituting a further loosening mechanism, comprising a striker 39 rotatably supported by a support rod 40 which is rotatably mounted to the container support 36, and a torsion spring 42. The use of the striking mechanism 38 will become clear below.

In addition to the above, springs 44a, 44b, 44c, 46a, 46b, and 46c and rods 48a, 48b, and 48c are provided. Posts 49a, 49b, 49c, (seen in FIG. 2), projecting from the rear casing 30b, are also provided. The purposes of these components will be explained below.

As illustrated in FIG. 4A, each button 22 comprises a projecting portion 50 and a C-shaped portion 52. The projecting portion 50 is that part of the button 20 which is visible when the dispenser 10 is fully assembled, and comprises an indicium 54 which corresponds to the quantity of the particulate material with which the button is associated. The C-shaped portion 52 comprises two parallely extending side members 56. As best seen in FIG. 4B, each side member 56 comprises a through-going bore 58 which is of a larger diameter at a rear end 60 of the side member. The change in diameter is abrupt, giving rise to a shoulder 62.

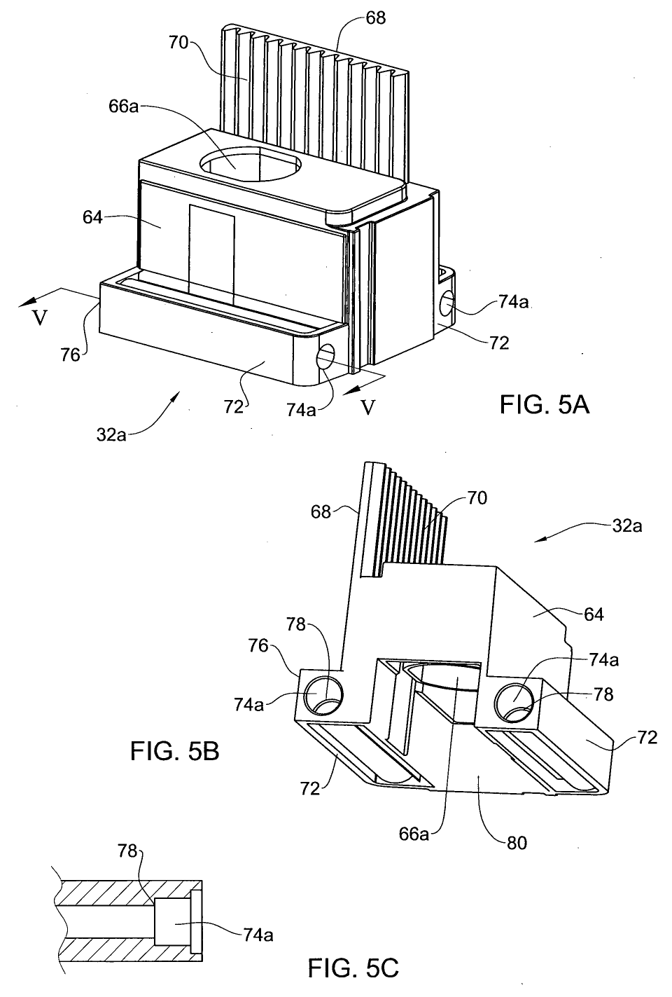

As illustrated in FIGS. 5A and 5B, the bottommost slide 32a comprises a central portion 64 with a dispensing chamber 66a, open at the top and bottom thereof, extending vertically therethrough. The volume of the dispensing chamber 66a is such as to hold the smallest predetermined quantity of the particulate material. A wall 68 having teeth 70 extends upwardly from one side of the central portion 64. Wings 72, each having a through-going bore 74a, project outwardly from the either side of the bottom of the central portion. The bore 74a is of a larger diameter at a rear end 76 of the slide 32a. The change in diameter is abrupt, giving rise to a shoulder 78 (seen in FIG. 5C), similar to what is illustrated in and described in reference to FIG. 4A. As seen in FIG. 5B only, the bottommost slide 32a further comprises a socket 80, adapted to snugly yet slidingly receive therein the spacer 34.

As illustrated in FIG. 6, the middle slide 32b comprises a slab-like main portion 82, having a dispensing chamber 66b, open at the top and bottom thereof, extending vertically therethrough, and through-going bores 74b at either end. The volume of the dispensing chamber 66b is such as to hold, together with the dispensing chamber 66a of the bottommost slide 32a, the next larger quantity of the particulate material. The structure of each bore 74b is similar to that of the bores 74a of the bottommost slide 32a, as described above. The middle slide 32b further comprises at a front face thereof a downwardly projecting panel 84 and a through-going slot 86 open to the back edge 88 of the slide 32b. The slot is of such a width so as to allow free passage therewithin of the wall 68 of the bottommost slide.

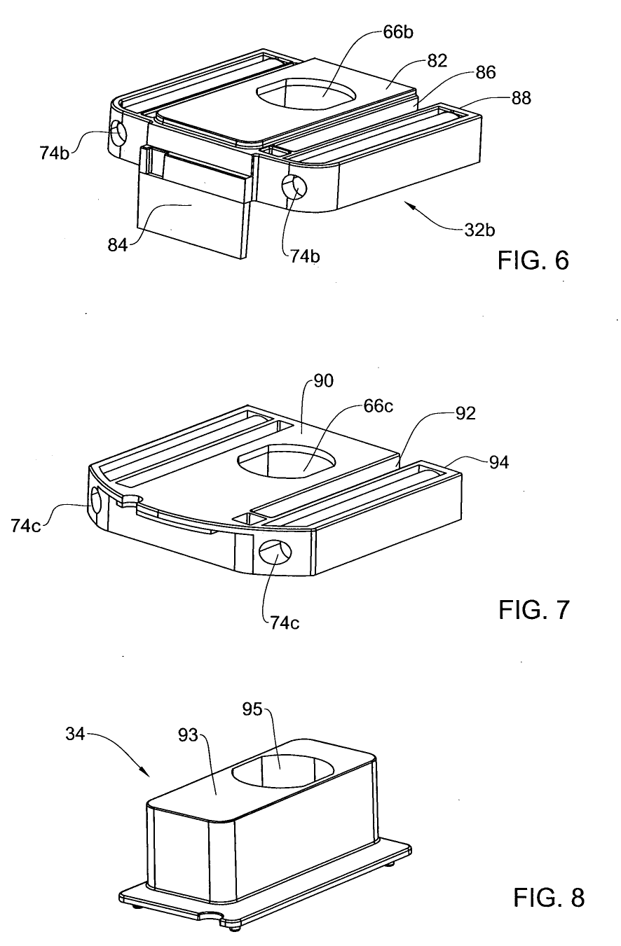

As illustrated in FIG. 7, the topmost slide 32c comprises a slab-like main portion 90, having a dispensing chamber 66c, open at the top and bottom thereof, extending vertically therethrough, and through-going bores 74c at either end. The volume of the dispensing chamber 66c is such as to hold, together with dispensing chambers 66a and 66b, the largest quantity of the particulate material. The structure of each bore 74c is similar to that of the bores 74a of the bottommost slide 32a, as described above. The topmost slide 32c further comprises a through-going slot 92 open to the back edge 94 of the slide 32b. The slot is of such a width so as to allow free passage therewithin of the wall 68 of the bottommost slide.

As illustrated in FIG. 8, the spacer 34 is sized so as to be snugly yet slidingly received within the socket 80 of the bottommost slide 32a. It comprises a top face 93, and a through-going aperture 95 constituting a particulate materials outlet and having a cross-section equivalent to those of dispensing chambers 66a, 66b, and 66c.

It will be appreciated that adjacent slides 32a, 32b, 32c and spacer 34 are in tight contact with each other, such that when the slides move, particulate materials within the dispensing chambers do not slip therebetween. However, this contact is not so tight as to limit the necessary movement. To this end, the slides 32a, 32b, 32c may be made from or coated with a low-friction material, such as polytetrafluoroethylene (PTFE, commonly sold under the trade name Teflon™).

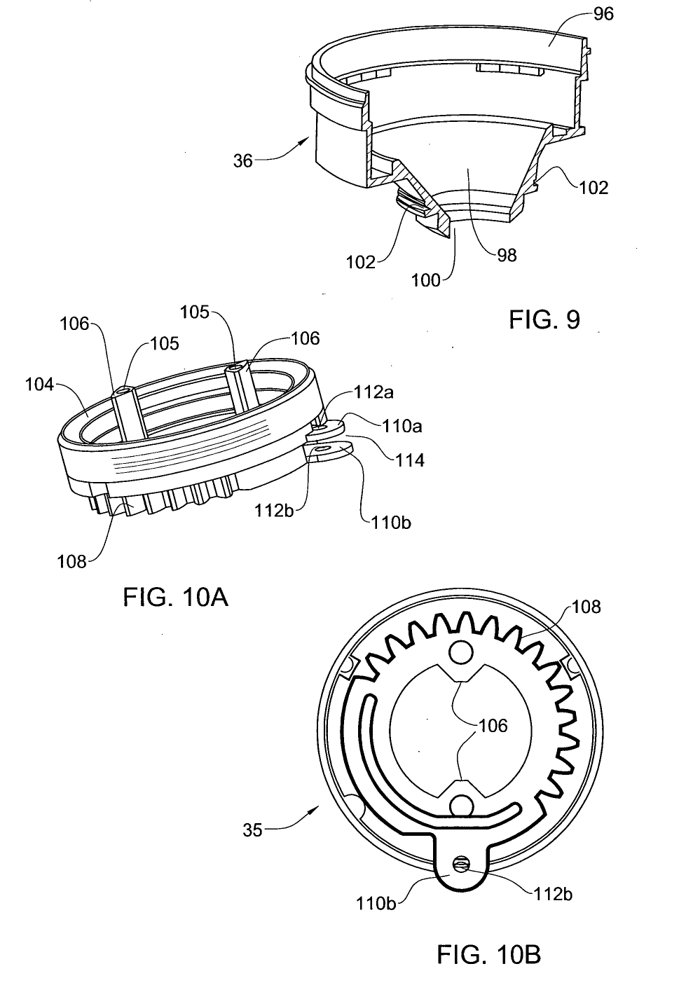

As illustrated in FIG. 9, the container support 36 comprises an upper rim 96 defining the opening 24 and adapted to receive therein the container and a funnel section 98. The upper rim 96 may be adapted to sealingly receive the container, helping to preserve the freshness of the particulate materials therein.

The funnel section 98 terminates in an opening 100, which constitutes a particulate materials inlet and may be no larger than any of the dispensing chambers 66a, 66b, and 66c. The opening 100 is in flow communication with the dispensing chamber 66c formed within the topmost slide 32c. A circumferential groove 102 is formed to the outside of the container support 36 near the top of the funnel section 98. When the dispenser is assembled, the opening 100 sits directly above the dispensing chamber 66c of the topmost slide 32c. It will be appreciated that, depending on the geometrical constraints of the dispenser 10, the opening 100 may be located eccentrically to the rest of the container support 36.

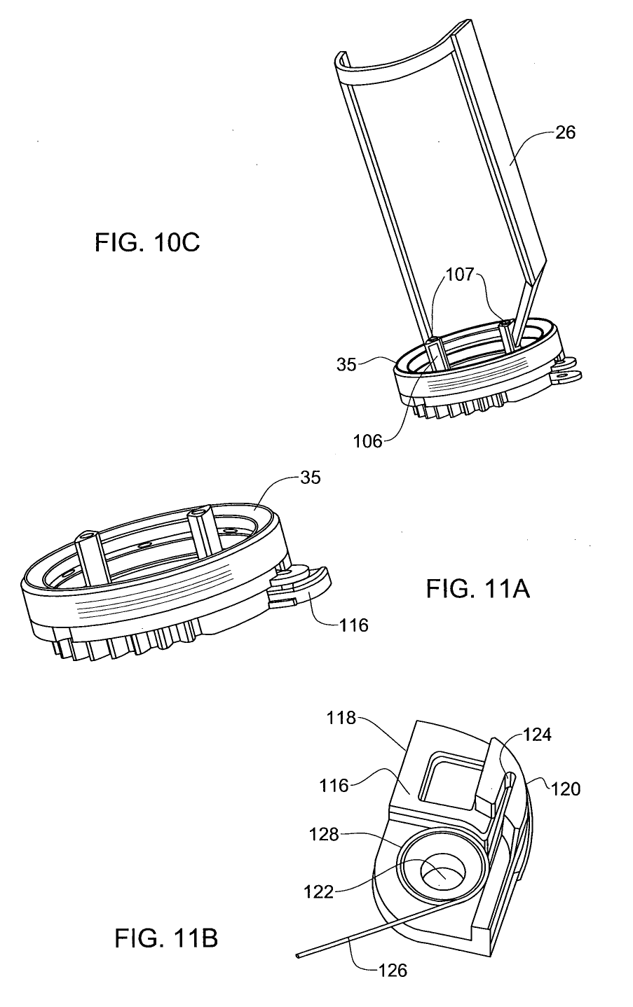

As illustrated in FIGS. 10A and 10B, the rotatable ring 35 comprises an inwardly directed rim 104 adapted to be rotatably received within the circumferential groove 102 of the container support 36. It further comprises two agitator supports 106, each having an aperture 105 adapted to receive a screw 107 for securing thereto the agitator 26 (see FIG. 10C). At least part of the bottom surface thereof comprises circumferentially arranged teeth 108, which are adapted to mesh with the teeth 70 of the bottommost slide 32a. Two bosses 110a, 110b having coaxial through-going apertures 112a, 112b and separated by a slot 114, project from the side of the rotatable ring.

As illustrated in FIG. 11A, a cam 116 is help retained between bosses 110a, 110b. As seen in FIG. 11B, the cam 116 is formed having a flat leading face 118 and a curved trailing face 120. The cam 116 further comprises a through-going aperture 122, approximately the same size as the apertures 112a, 112b of the bosses 110a, 110b of the rotatable ring 35, and a perpendicularly extending slot 124. A torsion spring 126 is provided, with one end thereof being laterally restrained within the slot 124, and the coil 128 thereof being located such that it surrounds the aperture 122. It is pivotally held between the bosses 110a, 110b by a pin (not shown in FIG. 11B).

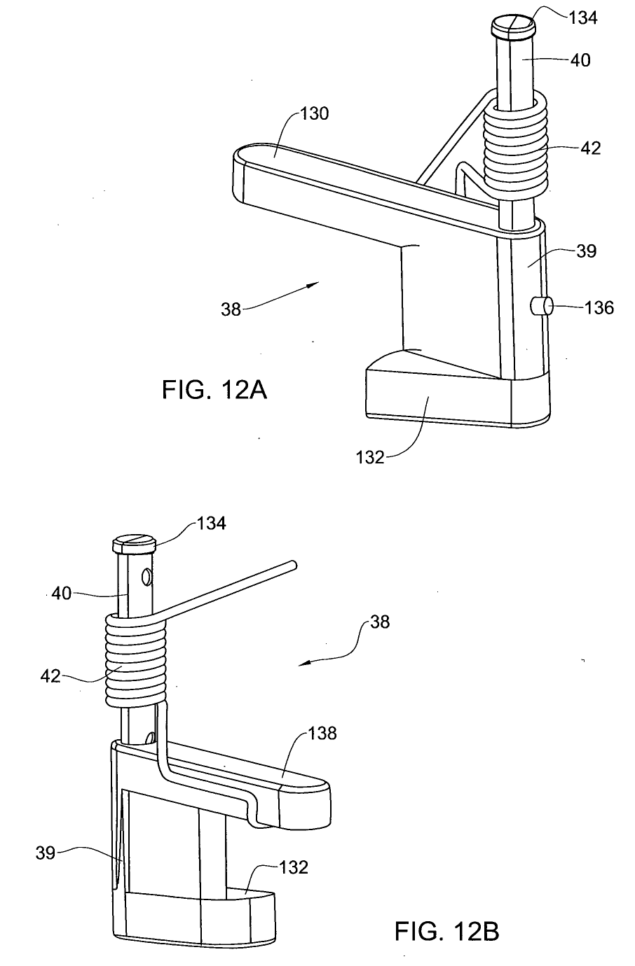

The structure of the striking mechanism 38 is seen more clearly in FIGS. 12A and 12B. The striker 39 comprises a striking arm 130 and a follower 132. The support rod 40 comprises a radially projecting head 134 and is received within a bore (not seen) of the striker 39. A pin 136 extends through the striker 39 and the support rod 40 so that the striker prevented from sliding from the support rod. The coil of the torsion spring 42 encircles the support rod 40. A first arm 133a thereof projects substantially perpendicularly to the striker 39 and a second arm 133b rests behind the striking arm 130 thereof. Reverting to FIG. 3, it is seen that in a neutral position of the striking mechanism 38, the first arm 133a bears against the side of the container support 36, and the second arm 133b urges the striking arm 130 toward the side of the container support.

It will be appreciated that the striking mechanism 38 and the cam 116, as illustrated in FIGS. 11A through 12B, are optional, and may be omitted without departing from the spirit and scope of the invention.

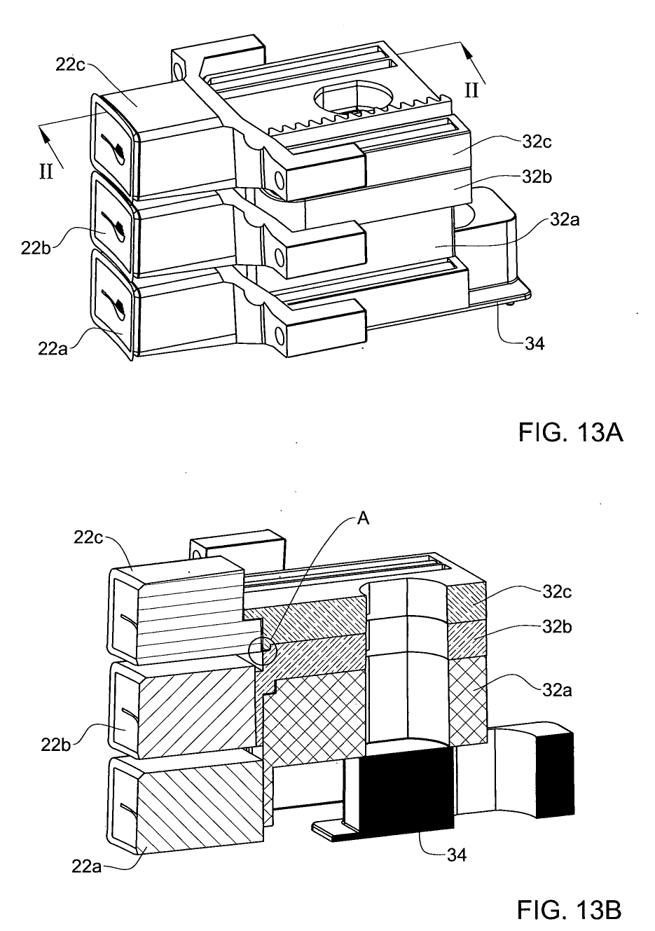

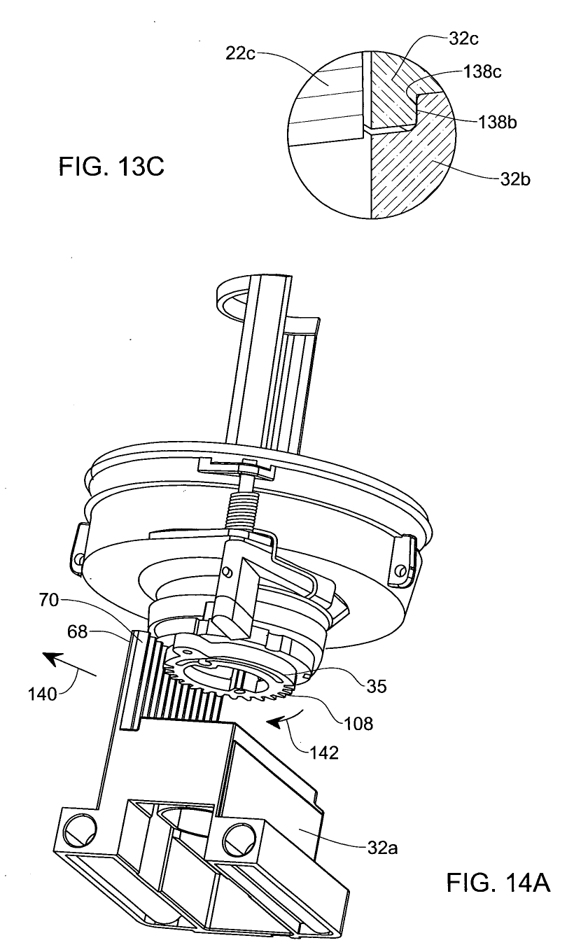

As illustrated in FIG. 13A, the three slides 32a, 32b, 32c are stacked, with each slide being situated behind its corresponding button 22a, 22b, 22c. The wall 68 of the bottommost slide 32a is received within the slots 86, 92 of the middle and topmost slides 32b, 32c. The spacer 34 is received within the socket 80 of the bottommost slide 32a. As is apparent in FIG. 13B, when the slides 32a, 32b, 32c are in their rest positions, the dispensing chambers 66a, 66b, 66c are vertically aligned, and are covered entirely at the bottom side by the top face 93 of the spacer 34.

When the bottommost button 22a is depressed, it bears only against the bottommost slide 32a, which results in only the bottommost slide being moved. When the middle button 22b is depressed, it bears against the downwardly projecting panel 84 of the middle slide 32b, which in turn bears against the bottommost slide 32b. Therefore, the bottommost slide 32a and the middle slide 32b move in tandem when the middle button 22b is depressed. When the uppermost button 22c is depressed, it bears against the topmost slide 32c. As is more readily seen in FIG. 13C, it also bears against the top of the middle slide 32b. In addition, the middle and top slides 32b, 32c are formed with corresponding shelves 138b, 138c, such that the middle slide is free to move backwardly (i.e., in the direction in which the buttons are depressed) without bearing on the topmost slide, but when the topmost slide moves backwardly, it bears against the middle slide. Therefore, when the topmost slide 32c moves backwardly, both it and the middle slide 23b move in tandem. As explained above, due to the presence of the downwardly projecting panel 84, the movement of the middle slide 32b results in tandem movement of the bottommost slide 32a. Therefore, depression of the topmost button 22c results in backward movement of all three slides 32a, 32b, 32c in tandem.

It will be appreciated that since the buttons 22a, 22b, 22c are not attached to their corresponding slides 32a, 32b, 32c, when a slide is moved as a consequence of a button different from its corresponding button being depressed, the slide moves backwardly without any movement of its corresponding button. For example, when the middle button 22b is depressed, both the middle slide 32b and the bottommost slide 32a move backwardly. However, the bottommost button 22a does not move with the bottommost slide 23a.

When each slide 32a, 32b, 32c is moved fully backward, the displacement causes its respective dispensing chamber 66a, 66b, 66c to become aligned with the aperture 95 in the spacer 34.

Reverting to FIGS. 2 and 3, each button 22a, 22b, 22c is associated with two of springs 44a, 44b, 44c and two of posts 49a, 49b, 49c. The springs are received within the large-diameter side of the through-going bore 58 of each button, bearing against the shoulder 62 thereof. The posts 49a, 49b, 49c extend through the springs 44a, 44b, 44c and the bores 58. When a button is depressed, it is carried along the length of its corresponding posts, and the corresponding springs are compressed. When the button is released, the springs urge the button back to its initial position.

In addition, each slide 32a, 32b, 32c is associated with two of springs 46a, 46b, 46c and two of rods 48a, 48b, 48c. The springs are received within the large-diameter side of the through-going bore 74a, 74b, 74c of each slide, bearing against the shoulder 78 thereof. The rods 48a, 48b, 48c extend through the springs 46a, 46b, 46c and the bores 74a, 74b, 74c. The springs 46a, 46b, 46c bear against the rods 48a, 48b, 48c, biasing them against the rear casing 30b. When a button is pressed which causes a slide to moves backwardly, the slide is carried along the length of its corresponding rods, and the corresponding springs are compressed. When the button is released, the springs urge the slide back to its initial position.

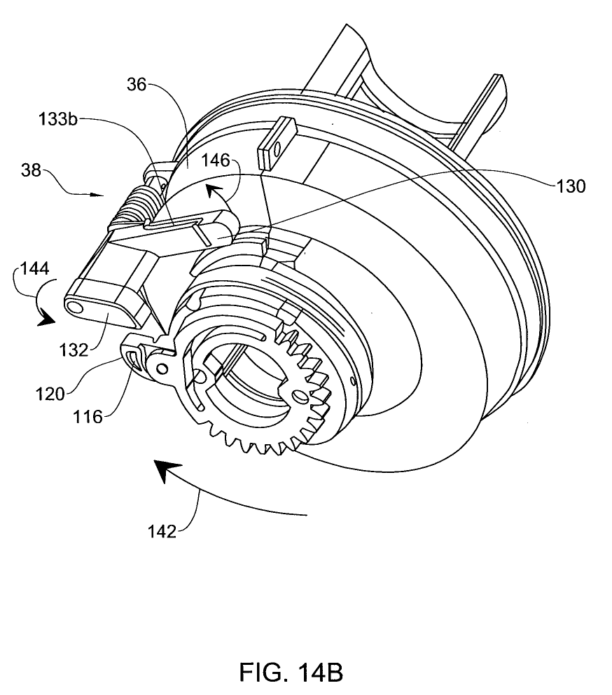

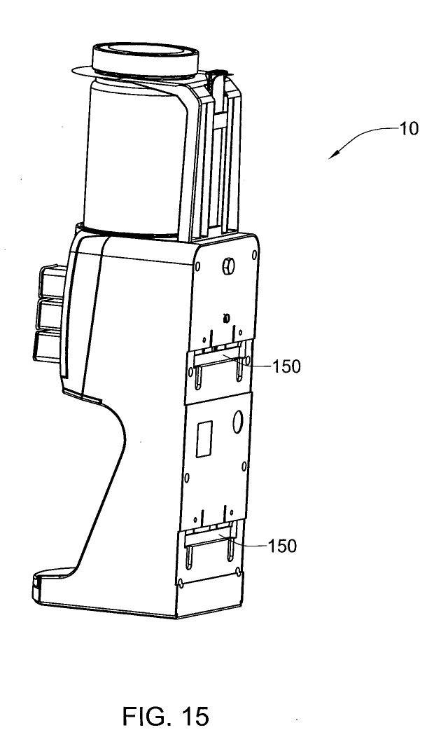

As illustrated in FIG. 14A, when the bottommost slide 32a is displaced backwardly (the middle and topmost slides are omitted from FIG. 14 for clarity), it moves in the direction indicated by arrow 140. Since the teeth 70 of the wall 68 of the bottommost slide mesh with the teeth 108 of the rotatable ring 35, the movement of the slide results in a rotational movement of the rotatable ring in the direction indicated by arrow 142. This, in turn, results in a corresponding rotation of the agitator 26. It will be appreciated that since the bottommost slide 32a moves in tandem with each of the other slides 23b, 32c, as explained above, depression of any of the buttons 22a, 22b, 22c, will result in rotational movement of the rotatable ring 35.

As seen more clearly in FIG. 14B, rotation of the rotatable ring 35 results in triggering of the striking mechanism 38. As the rotatable ring rotates in the direction indicated by arrow 142, the cam 116 approaches and then bears against the follower 132 of the striking mechanism 38. The striking mechanism 38 rotates about the support rod 40 in the direction indicated by arrow 144, which causes the striking arm 130 to oppose the force of the second arm 133b and move in the direction indicated by arrow 146 away from the side of the container support 36. Once the cam 116 passes the follower 132, the torsion spring 42 forces the striker 32 to quickly return to its neutral position, causing the striker arm 130 to strike the side of the container support 36. When the rotatable ring 35 returns to its initial position, the curved trailing face 120 thereof contacts the follower 132, causing the cam to rotate about its pin so that it may pass next to it. Once the cam 116 has passed the follower 132, the torsion spring 126 located thereon urges the cam back to its initial position.

During operation of the dispenser 10, the above actions take place, as follows:
the dispenser is in an initial state, wherein:
   the slides 32a, 32b, 32c are in a first position, biased toward the front casing 30a of the dispensing portion 20, the dispensing chambers 66a, 66b, 66c thus being situated below the opening 100 of the container support 36 and in flow communication therewith;
   the dispensing chambers are situated above the top face 93 of the spacer 34;
   the dispensing chambers are filled with the particulate material, which are prevented from falling out by their placement directly above the top face of the spacer;
one of the buttons 22a, 22b, 22c is depressed by a user;
depending on which button is depressed, one or more of the slides 32a, 32b, 32c is moved backwardly toward a second position (if more than one, they move in tandem), including at least the bottommost slide 32a;
the following takes place simultaneously:
   as the slides move backwardly, the dispensing chambers 66a, and possibly one or more of 66b, 66c, are positioned over and in flow communication with the aperture 95 of the spacer 34, which results in the particulate material therein being dispensed (i.e., it falls through the aperture);
   the teeth 70 on the wall 68 of the bottommost slide 32a, which are meshed with the circumferentially arranged teeth 108 of the rotatable ring 35, causing it to rotate, having a two-pronged effect:
      a the agitator 26 rotates within the container 12, loosening the particulate material therein;
      a the striker 130 moves away from the side of the container support 36, and subsequently strikes the side of the container support, which further loosens the particulate material within the container;
the slides 32a, 32b, 23c return to their initial positions, and are filled with the particulate material from the container 12 above. The dispenser 10 is thus returned to its initial state.

It will be appreciated that more dispensing chambers being moved in tandem over the aperture 95 of the spacer 34 will result in more particulate materials being dispensed, and thus to a stronger beverage. Thus, a user may selectively dispense particulate materials in accordance with the amount of particulate materials desired, such as in accordance with the strength of beverage desired.

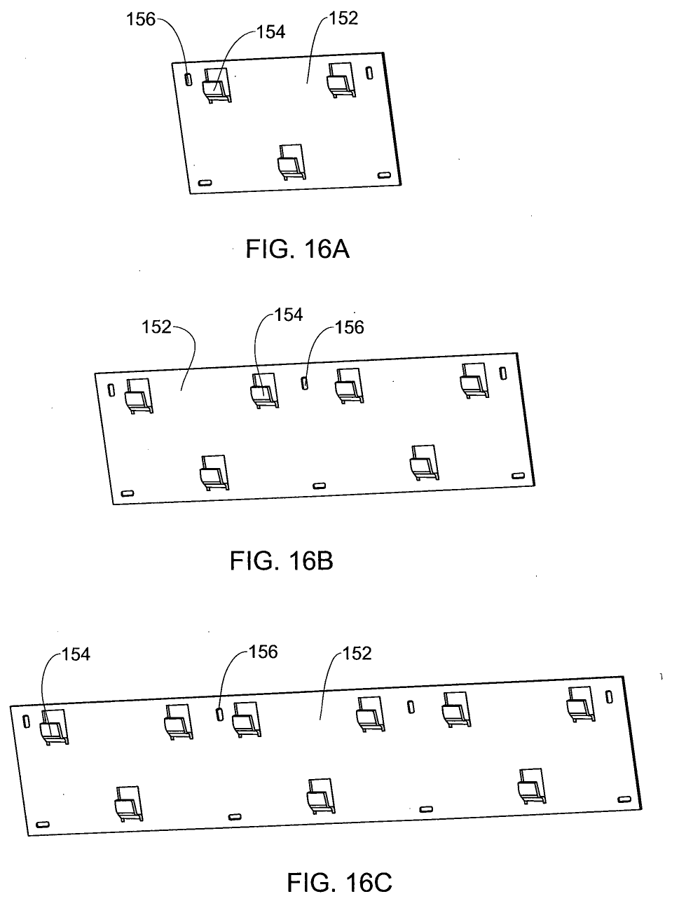

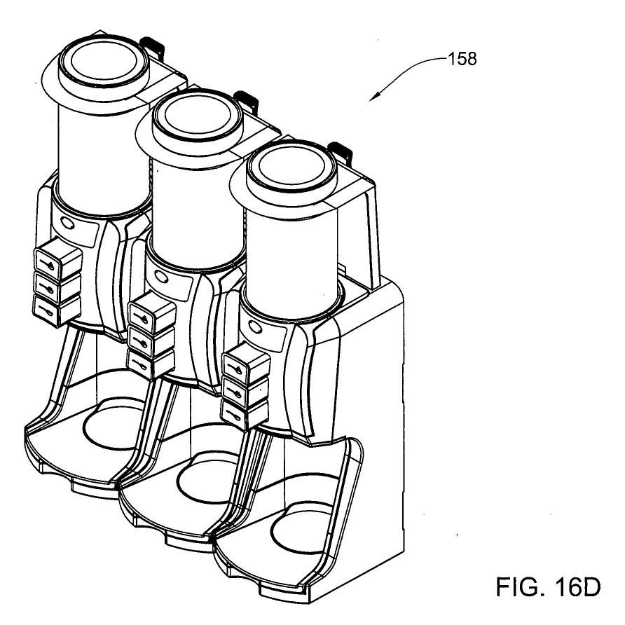

As illustrated in FIG. 15, the dispenser 10 may be formed with slots 150. As illustrated in FIG. 16A, a mounting plate 152 may be provided having hooks 154 adapted to be received within the slots 150, thereby supporting the dispenser 10. Through-going apertures 156 are further provided on the mounting plate 152. Each aperture 156 is sized to as to receive therein a screw (not illustrated) or other similar piece of hardware so that it may be mounted on a wall or other generally vertical surface. As illustrated in FIGS. 16B and 16C, the mounting plate 152 may be constructed so as to hold several dispensers, so that several dispensers 10, each dispensing a different type of particulate material (e.g., several varieties of coffee) may be mounted together to constitute a single dispensing array 158, for example as illustrated in FIG. 16D.

In addition to the example described above, one or more modifications may be introduced without departing from the spirit and scope of the invention. Some of these modifications will be described below.

As illustrated in FIG. 17A, the bottommost slide 32a may comprise a clapper initializer 166 and a protrusion 168 having a substantially flat striking surface 170 projecting upwardly from one of the wings 72. In addition, a clapper 172, made of a flexible material such as this steel or another metal, is provided. The clapper 172 is shown in FIG. 5D in its usual position relative to the bottommost slide 32a, but it will be appreciated that, in practice, it will need to be suspended, such as from the rear casing 30b (not seen in FIG. 5D). The clapper initializer 166 projects lower than the protrusion 168.

In use, when the bottommost slide moves backwardly towards its second position, the clapper initializer 166 deflects the clapper 172 so that it bends from its initial position. When the clapper 172 has been deflected to an extent that it clears the top of the clapper initializer 166, it springs back into its initial position. By this time, the protrusion 168 is located such that the striking surface 170 thereof is impacted by the clapper 172 upon its return. The geometries of the clapper initializer 166 and the protrusion 168 are such that the clapper 172 returns to its original position and impacts the protrusion when the slides 32a, and possibly one or more of 32b, 32c, are located such that the dispensing chambers 66a, and possibly one or more of 66b and 66c are positioned fully over the aperture 95 of the spacer 34. The noise produced upon impact of the clapper 172 with the striking surface 170 of the protrusion 168 is an audible signal to a user that the button 22a, 22b, or 22c, as the case may be, has been fully depressed.

In addition, the clapper 172 may be formed with a weight 173. In this way, the bottommost slide 32a is agitated, thus loosening the particulate material therein, and assisting in dispensing thereof.

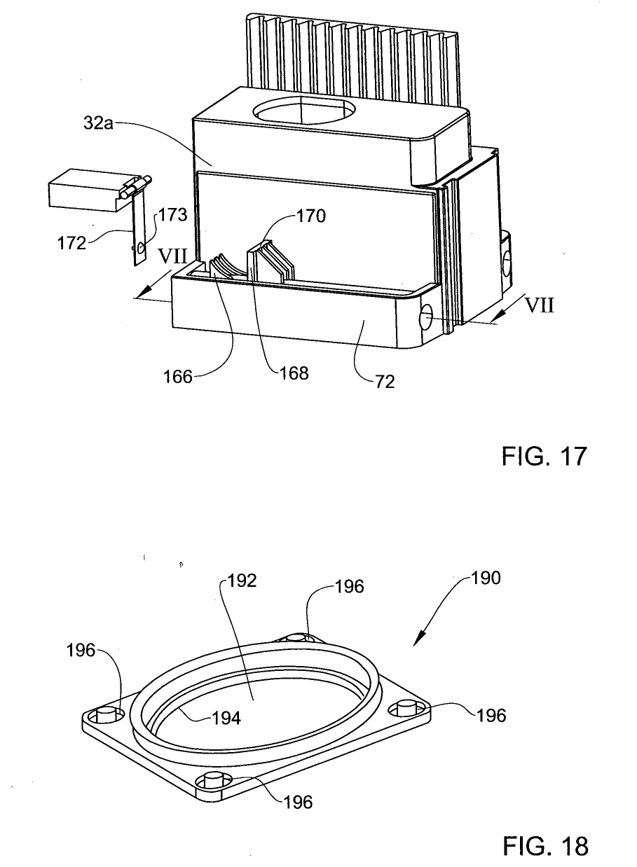

According to another modification, spacers 190, such as the one illustrated in FIG. 18, may be placed between adjacent slides 32a, 32b, 32c. Each spacer 190 comprises a through-going aperture 192, adapted to be located around the perimeter of each dispensing chamber 66a, 66b, 66c. The inner rim 194 of the aperture 192 is flush with the bottom surface of the spacer, such that it serves as a blade to prevent any particulate material from slipping thereunder. Each spacer 190 may further comprise seats 196 for receiving therein a spring (not seen). The corresponding location on the slide immediately above comprises corresponding seats. The springs are provided so as to bias the spacer 190 toward the slide immediately therebelow, thereby ensuring that none of the particulate material becomes trapped between the spacer and the slide. In addition, the biasing of the spacer toward the slide lowers the tolerances required needed during manufacture.

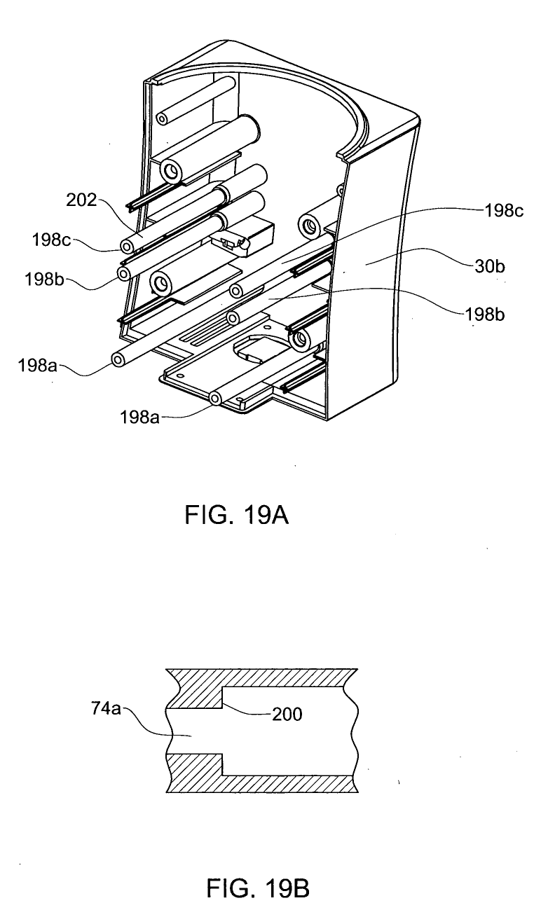

According to another modification, the rods 48a, 48b, 48c may be omitted, and instead the rear casing 30b may be formed with shafts 198a, 198b, 198c projecting therefrom, as seen in FIG. 19A, and situated so as to be received within the bores 74a, 74b, 74c formed within each of the slides 32a, 32b, 32c. Each of the shafts 198a, 198b, 198c is formed with a first portion 202 of a first diameter, and a second portion 204, located toward the rear, of a larger diameter, giving rise to a shoulder 206. Per this embodiment, the shoulder 78 described with reference to FIG. 5C may be omitted, i.e., the diameter of the bore 74a at the rear end 76 of the slide 32a may be of constant diameter. However, as illustrated in FIG. 19B, the diameter of the bore immediately adjacent the front end of the bore 74a is smaller than the remainder of the diameter of the bore. A shoulder 200 is formed at the interface between these two diameters. The smaller diameter of the bore 74a is such so as to receive therein the first portion 202 of the shaft, and the larger diameter is such so as to receive therein the second portion 204 of the shaft. The springs 46a, 46b, 46c are disposed within the space between the two shoulders 206, 200. The length of each of the springs 46a, 46b, 46c may be longer than the distance between the two shoulders 206, 200. Since each spring is already compressed when the buttons 22a, 22b, 22c are in their rest position, the resistance of each spring will vary less during pushing of the buttons.

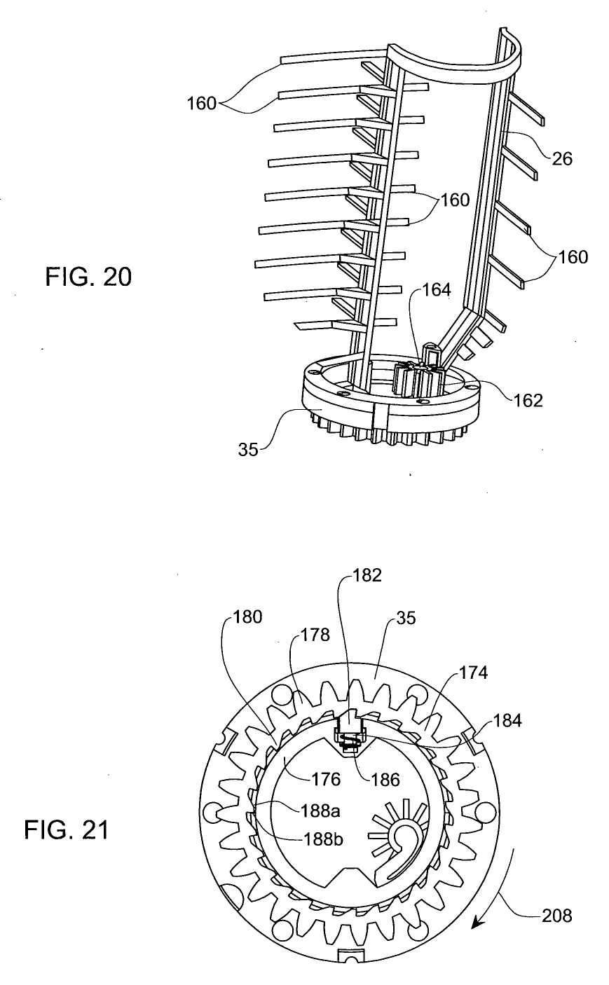

According to a further modification, as illustrated in FIG. 20, the agitator 26 may comprise a plurality of prongs 160 extending therefrom. The prongs 160 help to further loosen the particulate material within the canister, and are adapted to reach the interior wall thereof, in order to scrape particulate material therefrom.

In addition, the rotatable ring 35 may comprise a toothed wheel 162 adapted to rotate about a pin 164. The toothed wheel 162 is situated so as to contact the bottom of the rim 104 of the rotatable ring 35, thereby impacting particulate material which may gather there, and displacing it off.

According to a still further modification, as illustrated in FIG. 21, a ratchet-wheel 174 is provided about a downwardly-facing collar 176 of the rotatable ring 35. The ratchet-wheel 174 comprises circumferentially arranged teeth 178 projecting radially outwardly therefrom, and ratchet-teeth 180 facing radially inwardly therefrom. A pawl 182 is slideably mounted to the rotatable ring 35 about a pin 184, and a spring 186 biases it radially outwardly. The ratchet-teeth 180 are formed such that a leading face 188a thereof is disposed at an angle, which may be more than 45°, to a radial line which passes therethrough, and a trailing face 188b thereof is substantially parallel to a radial line which passes therethrough. The pawl 182 is formed correspondingly so as to fit within the space between two adjacent ratchet-teeth 180.

During use, the toothed wall 68 of the bottommost slide 32a (not seen in FIG. 21) imparts, upon pushing of the button, a rotational movement to the ratchet-wheel 174 in a direction indicated by arrow 208. Due to the shape of the leading faces 188a of the ratchet-wheel 174 and of the pawl 182, the ratchet-wheel pushes the pawl radially inwardly, and rotates independently of the downwardly-facing collar 176 of the rotatable ring 35. As each ratchet-tooth 180 clears the pawl 182, the pawl is biased into the subsequent space between two adjacent ratchet-teeth. As the bottommost slide 32a returns forwardly, the ratchet-wheel 174 rotates in a position opposite that indicated by arrow 208. The trailing face 188b of the ratchet-tooth 180 which is adjacent the pawl 182 bears against it, which causes the rotatable ring to rotate. According to this modification, the agitator 26 always rotates in the same direction.

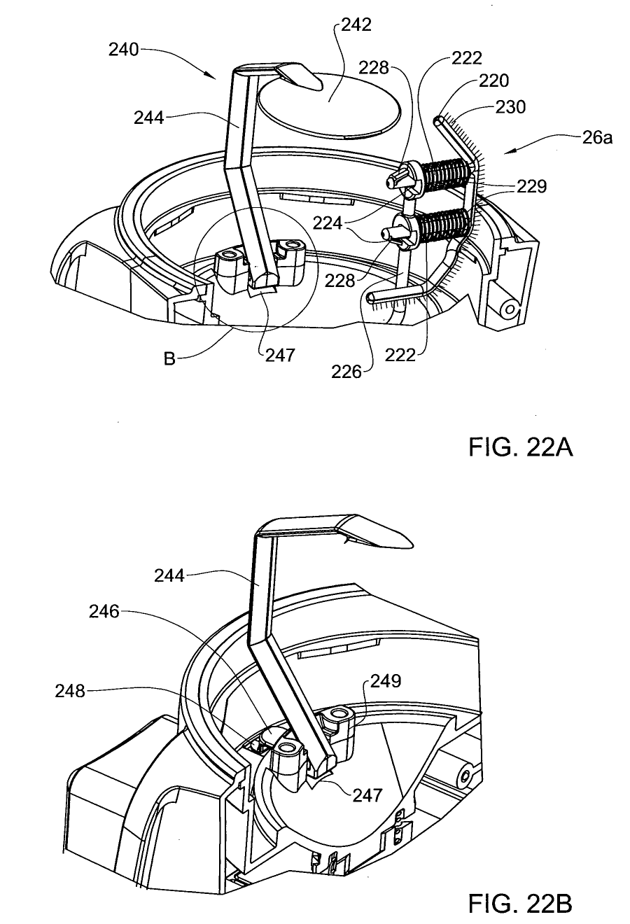

According to further modifications, as illustrated in FIG. 22A, the dispenser 10 may comprise a modified agitator, generally indicated at 26a, and/or a canopy, generally indicated at 240.

The modified agitator 26a comprises a container-bearing portion 220 rigidly attached to two plungers 222 which are received within apertures 224 formed within a support 226. A locking member 228 is formed on a distal end of each plunger 222, adapted to allow the plunger to be passed through the aperture 224, and subsequently to prevent its exit therefrom. A spring 229 is provided around each plunger 222 between the container-bearing portion 220 and the support 226. In addition, short, stiff bristles 230, formed of the material of the container-bearing portion 220, may project therefrom.

In use, the modified agitator is adapted to rotate within the canister, as described above with reference to FIG. 14. The springs 229 provide a force which directs the container-bearing portion 220 to bear against the interior wall of the container. Thus, when it rotates, it is adapted to scrape any particulate material adhering to the interior of the container. The bristles 230 further scrape the interior of the container, which loosens finer particles which may be adhered to the interior of the container.

The canopy 240 comprises a disk 242 and a boom 244. The boom, at a first end, is attached to the disk 242, and, at a second end, as illustrated in FIG. 22B, comprises a pedal 246 and with a foot 248. In addition, the funnel section 98 of the container support 36 is modified to comprise a sloped portion 247 as well as a canopy support 249, within which the canopy is adapted to pivot. It will be appreciated that the canopy comprises two round projections (not seen) which project therefrom into the canopy support, adapted to allow pivoting of the canopy therewithin.

When no container is on the dispenser, the canopy is at a rest position (not shown) wherein it is pivoted inwardly. The sloped portion 247 formed within the funnel section 98 allows this pivoting. In this way, a container is free to be placed on the dispenser without encountering interference from the canopy 240. When a container is placed on the dispenser, it bears down against the pedal 246, pivoting the canopy 240 into an upward position, as illustrated in FIG. 22. The disk 242 is then located directly above the opening 100 of the container support 36, through which particulate material enters the dispensing chambers 66a, 66b, and 66c. Thus, particulate material is prevented from falling directly toward the opening 100, thus ensuring that the opening does not become clogged by particulate material amassed therein.

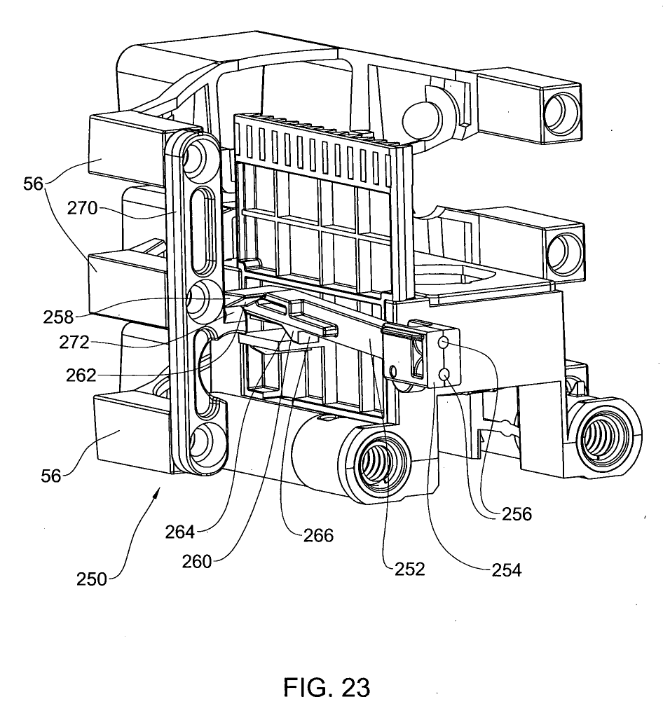

According to a further modification, as illustrated in FIG. 23, there is provided a delay mechanism, generally indicated at 250. The delay mechanism 250 comprises an arm 252 constituting a restraining mechanism and pivotally articulated to a base 254, which is secured to the rear casing 30b (not seen in FIG. 23). For this purpose, two threaded bores 256 are provided in the rear end of the base 254, which are used to be engaged by screws passing through the rear end of the rear casing 30b. The arm 252 is provided with a sideways-projecting lifting protrusion 258, and a downwardly-projecting blocking protrusion 260. The lifting protrusion 258 comprises a sloped undersurface 262, which slopes upwardly toward the rear end of the dispenser. The blocking protrusion 260 comprises a sloped undersurface 264, which slopes upwardly toward the front end of the dispenser, and a vertical blocking wall 266 facing the rear end of the dispenser. In addition, the delay mechanism comprises a control mechanism 270, which is disposed directly behind the extending side members 56 of the buttons 22, so that when any of the buttons is depressed, the control mechanism moves rearwardly. The control mechanism 270 comprises a support protrusion 272, which is disposed below the lifting protrusion 258 of the arm 252 when no buttons are depressed, pivoting the arm upwardly.

In addition, the wall 78 of the bottommost slide 32a is modified with an outwardly projecting rib 274, which lies in front of the blocking protrusion 260 of the arm 252 when no buttons are depressed.

In use, when any of the buttons 22 are depressed, the control mechanism 270 moves rearwardly therewith. As the support protrusion 272 of the control mechanism 270 moves rearwardly, the arm 252 pivots downwardly. At the same time, since, as described above, the bottommost slide 32a moves rearwardly irrespective of which button is depressed, the outwardly projecting rib 274 thereof passes by the blocking protrusion 260. Due to the sloped undersurface 264 of the blocking protrusion 260, the arm 252 may be pivoted upwardly as necessary to allow the blocking protrusion to pass. Once it has passed, the arm pivots downwardly, such that the blocking wall 266 of the blocking protrusion 260 is in the return path of the projecting rib 274 of the wall 78 of the bottommost slide 32a.

When the button is released, the springs 44a, 44b, 44c (not illustrated in FIG. 23) bear upon the control mechanism 270, returning the buttons to their original position, as described above. However, as the outwardly projecting rib 274 of the wall 78 of the bottommost slide 32a is in the return path of the projecting rib 274, it impedes its progress, and the bottommost slide 32a remains in its rearward position. When the control mechanism 270 returns to its original (forward) position, the support protrusion 272 slides under the sloped undersurface 262 of the lifting protrusion 258, pivoting the arm 252 upwardly. This causes the blocking protrusion 260 to be lifted, removing the blocking wall 266 thereof from the path of the outwardly projecting rib 274. The bottommost slide is then able to return to its original position, at a delay from the time that the button was released.

By providing a delay mechanism 250, such as described above, the bottommost slide 32c may serve in the place of a striking mechanism, as described above. When the bottommost slide is returned to its original position after being depressed, the striking force of the return serves to vibrate the device, loosening particulate material within, inter alia, the container 12, the dispensing chambers 66a, 66b, 66c, and/or a particulate materials outlet, such as the through-going aperture 95. However, if a user's finger or hand is in front of the button when this occurs, it may impede the progress of slide to the forward position. The delay mechanism 250 thus gives the user sufficient time to remove his finger or hand from in front of the button, so that the slide can return unimpeded to its forward position, preventing unwanted damping of the striking force.

Those skilled in the art to which this invention pertains will readily appreciate that numerous changes, variations and modifications can be made without departing from the scope of the invention mutatis mutandis. In addition, the dispenser according to the present invention can be adapted to dispense particulate materials for uses other than to make beverages, such as to mix dyes, dispense animal feed or fertilizer pellets, etc., without departing from the spirit and the scope of the invention.

1. A dispenser adapted to dispense one of at least two predetermined amounts of particulate materials from a container, the dispenser comprising:
(a) a container support;
(b) at least two dispensing chambers, each being movable from a first position wherein it is located so as receive particulate materials from the container to a second position wherein it is located so as to dispense particulate materials stored therein,
wherein a first of said dispensing chambers has a volume equal to that of a first predetermined amount, and said first dispensing chamber and at least one other dispensing chamber have a combined volume equal to a second predetermined amount.

2. A dispenser according to claim 1, wherein the dispensing chamber, is its first position, is below and in flow communication with a particulate materials inlet, and in its second position, is above and in flow communication with a particulate materials outlet.

3. (canceled)

4. A dispenser according to claim 1, wherein each of the at least two dispensing chambers is formed within a slide.

5. A dispenser according to claim 4, comprising wherein said slides are arranged vertically, such that when one of at least some of the slides is displaced, at least one additional slide is displaced in tandem therewith.

6. (canceled)

7. A dispenser according to claim 5, wherein all of the at least one additional slide successively contact the slide.

8. A dispenser according to claim 1, wherein the other dispensing chambers successively contact the first dispensing chamber.

9. A dispenser according to claim 8, wherein the first dispensing chamber is formed within a bottommost slide.

10. (canceled)

11. (canceled)

12. (canceled)

13. A dispenser according to claim 4, further comprising at least two buttons, each associated with a different slide and corresponding to dispensing a different predetermined amount of particulate material, and a delay mechanism configured to temporarily restrain at least one slide from returning to a forward position after a button is depressed and released.

14. A dispenser according to claim 13, wherein said delay mechanism comprises:
a restraining mechanism configured, in a first position, to prevent said at least one slide from returning to its forward position and, in a second position, to allow said at least one slide to return to its forward position; and
a control mechanism configured to move in concert with said button and to bring said restraining mechanism from its first position to its second position when the button is at or near its forward position.

15. (canceled)

16. (canceled)

17. A dispenser according to claim 1, further comprising at least one loosening mechanism for loosening the particulate material, said loosening mechanism being responsive to a movement associated at least with the movement of at least one of the dispensing chambers from its first position to its second position.

18. A dispenser according to claim 17, wherein the loosening mechanism is configured for loosening the particulate materials within the container.

19. (canceled)

20. (canceled)

21. A dispenser according to claim 17, wherein the loosening mechanism is a striking device configured to strike the container or a component of the dispenser in contact therewith.

22. A dispenser according to claim 17, wherein said loosening mechanism comprises a container-bearing portion configured to be biased toward an inner wall of container when received within the container support.

23. (canceled)

24. A dispenser according to claim 18, further comprising a rotatable ring configured to rotate in response to the displacement of at least one of the dispensing chambers from its first position to its second position and to activate the loosening mechanism.

25. (canceled)

26. (canceled)

27. (canceled)

28. A dispenser according to claim 1 comprising:
a clapper;
a clapper initializer configured for movement with the first of the dispensing chambers; and
a striking surface being in vibrational communication said dispensing chamber;
wherein said clapper, clapper initializer, and striking surface are arranged such that upon movement of the dispensing chamber toward its second position, the clapper initializer displaces or deforms the clapper from a rest position thereof, and upon further movement of the dispensing chamber to the second position, the clapper strikes the striking surface.

29. (canceled)

30. (canceled)

31. A dispenser according to claim 17, wherein said loosening mechanism comprises a toothed wheel.

32. (canceled)

33. A dispenser according to claim 1, further comprising a canopy configured, at least when a container is received within the container support, to prevent particulate material from falling directly from the container into said dispensing chambers.

34. (canceled)

35. (canceled)

36. (canceled)

37. A dispenser according to claim 1, configured to receive therein a retail canister of particulate materials.

38. A dispenser according to claim 1, configured to selectively dispense from two or more containers.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)
